(19) United States
(12) Patent Application Publication
(10) Pub. No.: US 2011/0161583 A1
(43) Pub. Date: Jun. 30, 2011

(54) MEMORY CARD AND MEMORY SYSTEM INCLUDING SEMICONDUCTOR CHIPS IN STACKED STRUCTURE

(76) Inventor: Sun-pil Youn, Seoul (KR)

(21) Appl. No.: 12/959,586

(22) Filed: Dec. 3, 2010

(30) Foreign Application Priority Data
Dec. 30, 2009 (KR) 10-2009-0134932

(51) Int. Cl. G06F 12/00

(52) U.S. Cl. 711/115; 711/E12.001

(57) ABSTRACT

A memory card and memory system are disclosed. The memory card includes a plurality of ports formed on an external surface of the memory card, a memory controller coupled to the plurality of ports and configured to communicate with an external host through the ports, and to generate a plurality of internal signals for controlling a memory operation based on signals received from the external host, and a memory device coupled to the memory controller and comprising at least two semiconductor chips, which are vertically stacked on each other. Each semiconductor chip comprises a plurality of through substrate vias for receiving the plurality of internal signals from the memory controller. The memory controller generates first and second internal signals based on a first signal received through a first port, and the first and second internal signals are provided to the memory device respectively through first and second signal paths that are electrically isolated from each other.

### CROSS-REFERENCE TO RELATED APPLICATIONS

This application claims the benefit of Korean Patent Application No. 10-2009-0134932, filed on Dec. 30, 2009, in the Korean Intellectual Property Office, the disclosure of which is incorporated herein in its entirety by reference.

### BACKGROUND

This disclosure relates to memory cards and memory systems, and more particularly, to a memory card and a memory system, which include a plurality of semiconductor chips in a stacked structure.

Generally, a memory system includes a memory device that includes memory cells for storing data, and a memory controller for controlling operations of recording and reading data according to a command received from an external host. A memory card constituting a type of the memory system is realized by integrating a memory device including at least one memory chip, and a memory controller for driving the memory device. Also, the memory card generally includes a nonvolatile memory device, for example, a memory device including a NAND memory cell, so as to store data.

In order to miniaturize the memory card, a memory cell having a large capacity may be integrated in a small area. A memory device in which a plurality of semiconductor chips are vertically stacked on each other may be used to improve the integration. By installing the semiconductor chips in the vertical stacked structure in the memory card, data storage capacity of the memory card may be improved.

The memory controller in the memory card receives and processes various command signals, data signals, and voltage signals from the external host, thereby generating various internal control signals for controlling the memory device. The internal control signals generated by the memory controller are transmitted to the memory device including the memory chips. Also, the memory device transmits the internal control signals received from the memory controller to each of the semiconductor chips through signal paths formed in the memory device.

However, noise may be generated in the transmitted internal control signals due to physical characteristics of a conductive line used to form the signal path. For example, when a large resistance is generated in a signal path for transmitting a power voltage or a ground voltage, noise generated in the power voltage or the ground voltage transmitted to the semiconductor chip is also large. Specifically, when large noise is generated in the power voltage or the ground voltage provided to a region where a memory cell of the semiconductor chip is disposed, memory operation characteristics deteriorate. In particular, when the integration of the memory card is increased, not only the memory operation characteristics largely deteriorate but also characteristics of the semiconductor chips may deteriorate due to noise, even when relatively small noise is generated in the power voltage or the ground voltage transmitted to the memory card.

### SUMMARY

According to one embodiment, a memory card is disclosed. The memory card includes a plurality of ports formed on an external surface of the memory card, a memory controller coupled to the plurality of ports and configured to communicate with an external host through the ports, and to generate a plurality of internal signals for controlling a memory operation based on signals received from the external host, and a memory device coupled to the memory controller and comprising at least two semiconductor chips, which are vertically stacked on each other. Each semiconductor chip comprises a plurality of through substrate vias for receiving the plurality of internal signals from the memory controller. The memory controller generates first and second internal signals based on a first signal received through a first port, and the first and second internal signals are provided to the memory device respectively through first and second signal paths that are electrically isolated from each other.

According to another embodiment, the memory card comprises at least one first semiconductor chip comprising a first region where a memory cell array for storing data is disposed, and a second region where a first plurality of through substrate vias for transmitting signals are disposed, and a second semiconductor chip comprising a third region where a logic array for controlling a memory operation is disposed, and a fourth region where a second plurality of through substrate vias for transmitting signals are disposed. At least one of the second through substrate vias is disposed to receive an external signal from outside the memory card.

According to another embodiment, the memory card comprises a plurality of ports formed on an external surface of the memory card, a memory controller for communicating to outside of the memory card through the plurality of ports, and configured to generate a plurality of internal signals for controlling a memory operation by using a signal received from outside the memory card, and a memory device comprising first and second semiconductor chips that are vertically stacked on each other. Each of the first and second semiconductor chips configured to receive the plurality of internal signals from the memory controller. In addition, the second semiconductor chip has a smaller area than the first semiconductor area, the second semiconductor chip is stacked on an upper portion of a part of the first semiconductor chip, and the memory controller is stacked on an upper portion of another part of the first semiconductor chip.

According to a further embodiment, a memory system is disclosed. The memory system includes a substrate, and a first semiconductor memory chip stacked on the substrate and comprising a first region where one or more memory cells for storing data are disposed, and a second region where at least a first through substrate via is formed. The memory system further includes a second semiconductor memory chip in a stack with the first semiconductor chip, and comprising a third region where one or more memory cells for storing data are disposed, and a fourth region where at least second and third through substrate vias are formed. The memory system additionally includes a controller stacked on the substrate. The is controller configured to transmit a signal through at least the third through substrate via to the first semiconductor memory chip.

### BRIEF DESCRIPTION OF THE DRAWINGS

Exemplary embodiments will be more clearly understood from the following detailed description, taken in conjunction with the accompanying drawings in which:

FIG. 1 is a block diagram of a memory card according to an exemplary embodiment;

FIG. 2 is a diagram of an external surface of the memory card of FIG. 1, according to one embodiment;

FIGS. 3A through 3E are exemplary diagrams for describing signal transmitting paths of the memory card of FIG. 2, according to certain embodiments;

FIG. 4 is an exemplary diagram of a memory card according to another embodiment;

FIGS. 5A through 5C are exemplary diagrams for describing signal transmitting paths in the memory card of FIG. 4, according to certain embodiments;

FIGS. 6A and 6B are exemplary diagrams for describing signal transmitting paths of external data and internal data signals, according to certain embodiments;

FIGS. 7A and 7B are exemplary diagrams of memory cards according to other embodiments;

FIG. 8 is a diagram of signals provided to a memory device included in a memory card, according to certain exemplary embodiments;

FIGS. 9A through 9C are exemplary diagrams of memory cards according to other embodiments; and

FIGS. 10A and 10B are exemplary diagrams of memory cards according to other embodiments.

### DETAILED DESCRIPTION

Various example embodiments will now be described more fully with reference to the accompanying drawings in which some example embodiments are shown. In the drawings, the thicknesses of layers and regions may be exaggerated for clarity.

Detailed illustrative embodiments are disclosed herein. However, specific structural and functional details disclosed herein are merely representative for purposes of describing example embodiments. This disclosure, may be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, a region illustrated as a rectangle may have rounded or curved features and/or a gradient at its edges rather than an abrupt change from a first surface to a second surface. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In order to more specifically describe example embodiments, various aspects will be described in detail with reference to the attached drawings. However, the present invention is not limited to example embodiments described.

FIG. 1 is a block diagram of a memory card 100 according to an exemplary embodiment. As shown in FIG. 1, the memory card 100 may include a memory controller 1000 and a memory device 2000. Also, a plurality of ports (not shown) are formed on an external surface of the memory card 100 so as to communicate with an external host (not shown). A power voltage VDD, a ground voltage VSS, a command signal CMD, and a data signal Data may be externally received through the ports. Other signals, such as an address signal, may also be received through the ports. The memory controller 1000 may receive and process the power voltage VDD, a ground voltage VSS, a command signal CMD, a data signal, and other signals to generate internal signals to be used in the memory card 100. The internal signals may be substantially identical to signals provided from the external host, or may be generated by performing a predetermined process on the signals provided from the external host. For example, certain internal voltage signals may have different (e.g., reduced or increased) voltage levels compared to the external voltage signals.

The memory device 2000 may include at least one semiconductor chip (not shown). For example, a plurality of semiconductor chips in a stacked structure may be installed in the memory device 2000. Also, some or all of the plurality of semiconductor chips may include one or more memory cell arrays, and each memory cell array may include nonvolatile memory cells, such as NAND memory cells. However, not all of the memory cells included in the memory device 2000 may be a NAND memory cell, and various types of memory cells, such as a DRAM memory cell, a NOR memory cell, etc. may be included in the memory device 2000. Also, the plurality of semiconductor chips included in the memory device 2000 may include a first semiconductor chip (not shown) operating as a master chip, and a second semiconductor chip (not shown) operating as a slave chip.

As shown in FIG. 1, the memory card 100 may receive a voltage signal, such as the power voltage VDD or the ground voltage VSS, from the external host through a respective port, and the received voltage signal is provided to the memory controller 1000. The ports may be, for example, nodes comprised of a conductive material and that are configured to pass electric signals between an external host and the memory card 100. The memory controller 1000 may provide the voltage signal as the voltage signal is to the memory device 2000, or may generate an internal voltage signal by processing the voltage signal and then provide the internal voltage signal to the memory device 2000. The memory controller 1000 may generate a first internal signal to be provided to the first semiconductor chip and a second internal signal to be provided to the second semiconductor chip from some or all of the signals provided from the outside of the memory card 100. For example, the memory controller 1000 may receive the power voltage VDD, and generate a first internal power voltage VDD_{—}1st and a second internal power voltage VDD_{—}2nd by using the power voltage VDD. Alternatively or additionally, the memory controller 1000 may receive the ground voltage VSS, and generate a first internal ground voltage VSS_{—}1st and a second internal ground voltage VSS_{—}2nd by using the ground voltage VSS. In addition, the memory controller 1000 may receive the command signal CMD and the data signal data, and generate an internal command signal CMD_I and an internal data signal Data_I by respectively using the command signal CMD and the data signal Data.

The memory device 2000 receives the internal signals from the memory controller 1000, and transmits the internal signals to the at least one semiconductor chip included in the memory device 2000. When the memory device 2000 includes the plurality of semiconductor chips that are vertically stacked on each other, each of the plurality of semiconductor chips may include a plurality of through substrate vias (TSVs) (e.g., vias that pass through a substrate, such as through silicon vias where the substrate comprises silicon) for transmitting the internal signals. Through substrate vias are shown in other of the figures. Some of the internal signals generated by the memory controller 1000 may be provided to the semiconductor chips through the same path. Also, the remaining internal signals may be provided to the semiconductor chips through different paths that do not overlap, and are thus electrically isolated from each other. For example, the first and second internal signals generated by processing a signal may be respectively provided to the first and second semiconductor chips through different dedicated paths. Referring to FIG. 1, the first internal power voltage VDD_{—}1st and the second internal power voltage VDD_{—}2nd are respectively provided to the first semiconductor chip and the second semiconductor chip through different paths, and the first internal ground voltage VSS_{—}1st and the second internal ground voltage VSS_{—}2nd are provided to the first semiconductor chip and the second semiconductor chip through different paths.

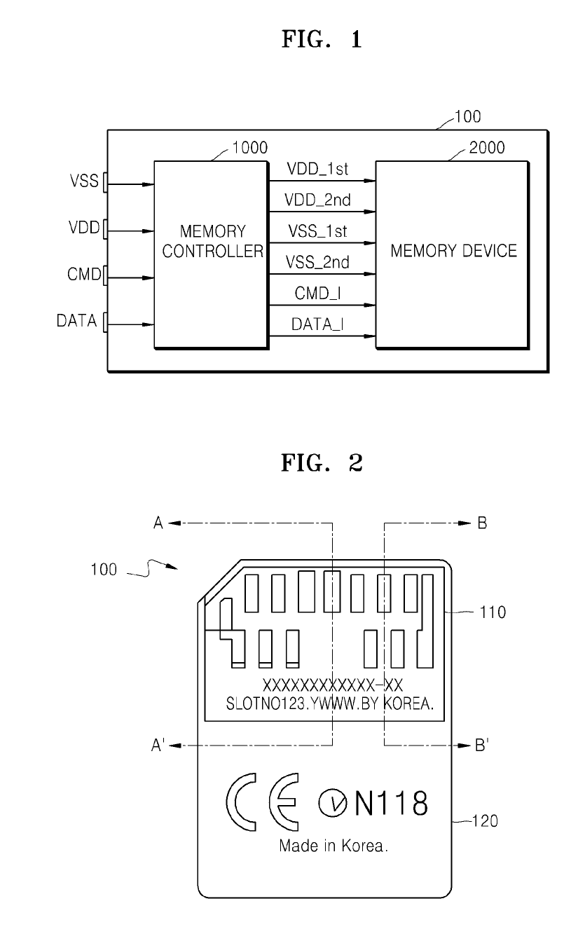

FIG. 2 is an exemplary diagram of an external surface of the memory card 100 of FIG. 1, according to one embodiment. As shown in FIG. 2, a memory controller and a memory device inside the memory card 100 are protected by a case 120. In addition, a port region 110, on which a plurality of ports are disposed, is formed on the external surface of the case 120. The memory card 100 is electrically connected to an external host through the plurality of ports on the port region 110, thereby receiving various control signals and data from the external host or providing information stored in the memory card 100 to the external host. In one embodiment, each of the ports formed on the external surface of the memory card 100 includes an electrical contact connected to the memory controller included in the memory card 100.

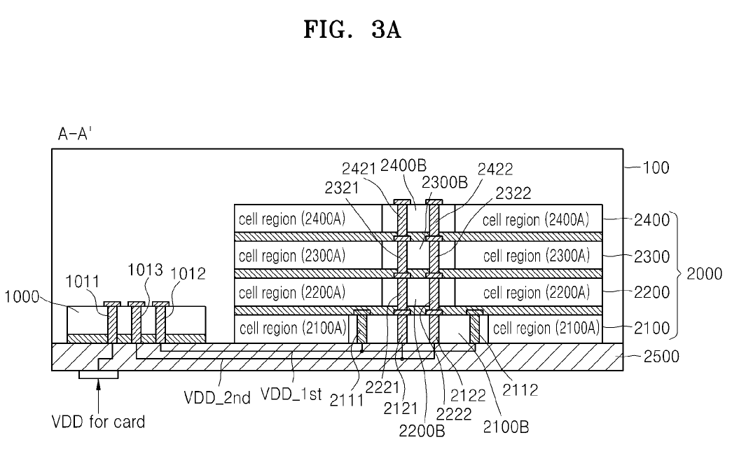

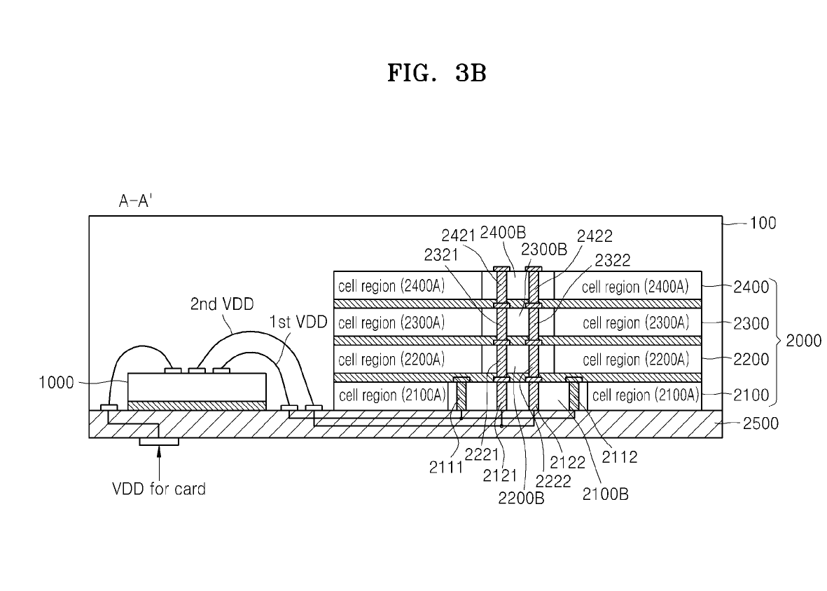

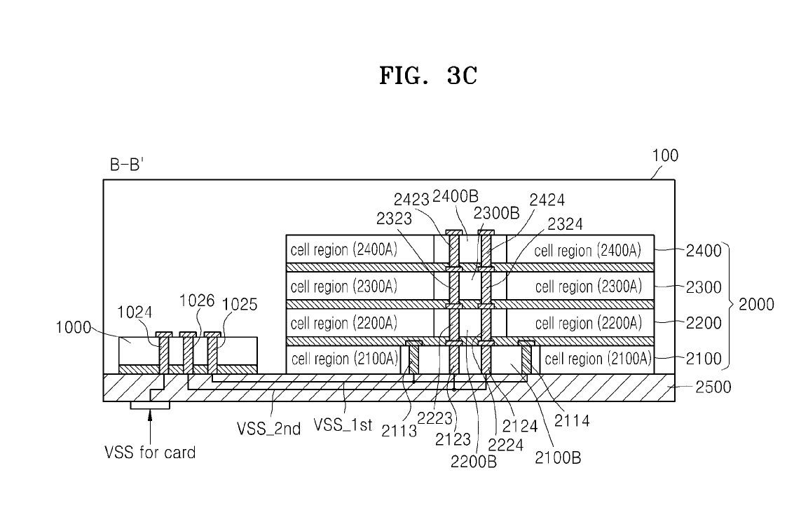

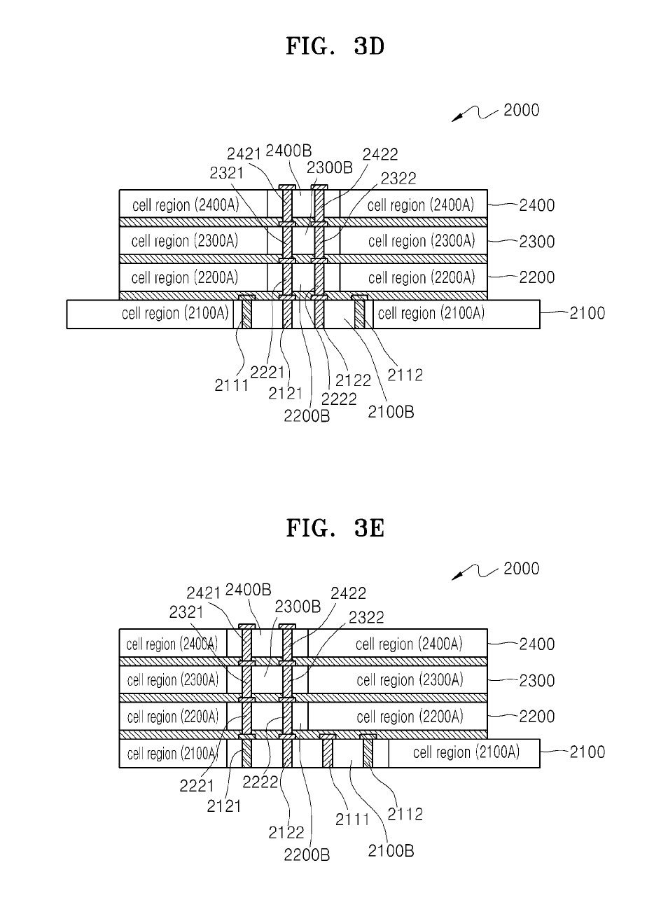

FIGS. 3A through 3E are exemplary diagrams for describing signal transmitting paths of the memory card 100 of FIG. 2, according to certain embodiments. For example, FIGS. 3A, 3B, 3D, and 3E are exemplary cross-sectional views taken along a line A-A′ of the memory card 100 of FIG. 2, and FIG. 3C is a cross-sectional diagram taken along a line B-B′ of the memory card 100 of FIG. 2. A plurality of semiconductor chips in a stacked structure may be included in the memory device 2000, and FIGS. 3A through 3E show four semiconductor chips 2100 through 2400 stacked on each other, for example, though other amounts may be used.

As shown in FIG. 3A, in one embodiment, the memory card 100 includes the memory controller 1000 and the memory device 2000, and for example, the memory device 2000 may include the four semiconductor chips 2100 through 2400 that are vertically stacked on each other. Here, one of the semiconductor chips 2100 through 2400 may be a first semiconductor chip 2100 operating as a master chip and the rest may be second semiconductor chips 2200 through 2400 operating as slave chips. The second semiconductor chips 2200 through 2400 may be vertically stacked on an upper part (e.g., top surface) of the first semiconductor chip 2100 and may be aligned, in one embodiment, so that outer edges of the chips align. The memory controller 1000 and the memory device 2000 may be each installed on one surface of a substrate 2500, and the memory controller 1000 and the memory device 2000 may communicate with each other through a circuit pattern formed on the substrate 2500.

In FIG. 3A, a chip operating as a master chip is disposed on the bottom and a plurality of chips operating as slave chips are stacked on the master chip, but locations of the master and slave chips are not limited thereto. For example, the memory device 2000 may be realized by disposing the plurality of chips operating as the slave chips on the bottom, stacking the master chip on the slave chips, and connecting the master chip to a substrate via a conducting unit, such as a bonding wire.

In one embodiment, the memory controller 1000 directly receives a signal from an external host through a port formed on an external surface of the memory card 100. FIG. 3A illustrates a port receiving the power voltage VDD, and the memory controller 1000 generates an internal power voltage by using the power voltage VDD received from the outside of the memory card 100. For example, the memory controller 1000 may generate the first internal power voltage VDD_{—}1st provided to the first semiconductor chip 2100 and the second internal power voltage VDD_{—}2nd provided to the second semiconductor chips 2200 through 2400, by using the received power voltage VDD.

A conductive unit for electrically connecting the memory controller 1000 to an external port, and another conductive unit for electrically connecting the memory controller 1000 and the memory device 2000 may be disposed in the memory card 100. For example, as shown in FIG. 3A, a port for receiving the power voltage VDD may be connected to a circuit inside the memory controller 1000 through a first through substrate via (TSV) 1011 (Hereafter, a through substrate via may be referred to as a “via” for convenience) disposed in the memory controller 1000, and the first and second internal power voltages VDD_{—}1st and VDD_{—}2nd generated in the memory controller 1000 from the power voltage VDD may be provided to the memory device 2000 respectively through a second via 1012 and a third via 1013 disposed in the memory controller 1000 and through a first and second conductive elements (e.g., wires or circuit patterns) located on the substrate 2500. The first and second internal power voltages VDD_{—}1st and VDD_{—}2nd may be provided to a semiconductor chip in the memory device 2000 through different paths. The paths may be electrically isolated, dedicated paths. Although not illustrated in FIG. 3A, apart from the power voltage VDD, at least one of a ground voltage, a command/address signal, and data signals may be used to generate first and second internal signals, and the generated first and second internal signals may be provided from the controller to a semiconductor chip in the memory device 2000 through different paths.

As shown in FIG. 3A, a memory cell array may be included in each of the semiconductor chips 2100 through 2400 of the memory device 2000. For example, a NAND memory cell array may be included in each of the semiconductor chips 2100 through 2400 as a nonvolatile memory cell array. However, the present disclosure is not limited thereto, and any other type of memory cell arrays may be included in the semiconductor chips 2100 through 2400, or different types of memory cells may be included in the semiconductor chips 2100 through 2400. Instead of a memory cell array, a logic array for performing a predetermined logic operation may be disposed in some of the semiconductor chips 2100 through 2400.

A conductive unit for transmitting a signal may be included in each of the semiconductor chips 2100 through 2400. For example, the first semiconductor chip 2100 includes a first region 2100A where memory cells are disposed, and a second region 2100B where one or more through silicon vias are disposed. Similarly, the second semiconductor chips 2200 through 2400 respectively include third regions 2200A through 2400A where memory cells are disposed, and fourth regions 2200B through 2400B where one or more through silicon vias are disposed. In one embodiment, outer edges of regions 2100A through 2400A vertically align with each other, and a center of regions 2100B through 2400B vertically align with each other, though other configurations may be implemented. Internal signals generated by the memory controller 1000 may also be transmitted to the semiconductor chips 2100 through 2400 through the through substrate vias disposed in the semiconductor chips 2100 through 2400.

When the first semiconductor chip 2100 operates as a master chip, a peripheral circuit (not shown) for driving the memory cell may be further included in the second region 2100B. In this case, an area of the second region 2100B of the first semiconductor chip 2100 may be larger than the fourth regions 2200B through 2400B of the second semiconductor chips 2200 through 2400. Also, when the first semiconductor chip 2100 operates as a master chip and the size of the memory cell array of the first semiconductor chip 2100 and the size of the memory cell array of each of the second semiconductor chips 2200 through 2400 are the same, the area of the first semiconductor chip 2100 may be larger than each area of the second semiconductor chips 2200 through 2400. In FIG. 3A, the areas of the first semiconductor chip 2100 and the second semiconductor chips 2200 through 2400 are the same, and in this case, the sizes of the memory cell array of the second semiconductor chips is larger than the size of the memory cell array of the first semiconductor chip 2100. Note that for each semiconductor chip 2100, 2200, 2300, and 2400, the regions 2100A, 2200A, 2300A, and 2400A, can be considered to each be a memory cell array. The array may have two portions, one on either side of the regions 2100B, 2200B, 2300B, and 2400B. Alternatively, each portion could be considered to be an array, such that each chip would have two memory cell arrays, separated by regions 2100B, 2200B, 2300B, and 2400B.

In order to transmit a signal between the semiconductor chips through a via, the vias included in each of the second semiconductor chips 2200 through 2400 may be aligned (e.g., in a vertical stack) with the vias included in the first semiconductor chip 2100. For example, first vias 2111 and 2112, and second vias 2121 and 2122 are disposed in the second region 2100B of the first semiconductor chip 2100. Also, third vias 2221, 2222, 2321, 2322, 2421, and 2422 are disposed in the fourth regions 2200B through 2400B of the second semiconductor chips 2200 through 2400. As shown in FIG. 3A, the third vias 2221, 2222, 2321, 2322, 2421, and 2422 of the second semiconductor chips 2200 through 2400 may be vertically aligned with the second vias 2121 and 2122 of the first semiconductor chip 2100. As such, in one embodiment, signal paths through the first vias 2111 and 2112 are separate and electrically isolated from signal paths through the second vias 2121 and 2122 and third vias 2221, 2222, 2321, 2322, 2421, and 2422.

In one embodiment, the first internal power voltage VDD_{—}1st generated in the memory controller 1000 may be transmitted to the first semiconductor chip 2100 through the first vias 2111 and 2112. Also, the second internal power voltage VDD_{—}2nd generated in the memory controller 1000 may be provided to the second semiconductor chips 2200 through 2400 through stacks of vias that include the second vias 2121 and 2122, and the third vias 2221, 2222, 2321, 2322, 2421, and 2422. Accordingly, the second via 1012 and third via 1013 of the memory controller 1000 are respectively connected to the first vias 2111 and 2112 and the second vias 2121 and 2122 of the first semiconductor chip 2100 through different circuit patterns on the substrate 2500. When the area of the second region 2100B is larger than the areas of the fourth regions 2200B, 2300B, and 2400B, and the center of the second region 2100B is aligned with the center of the fourth regions 2200B, 2300B, and 2400B, a part of the second region 2100B overlaps the fourth regions 2200B, 2300B, and 2400B. In order to efficiently form the signal transmitting path described above, the first vias 2111 and 2112 may be formed outside an area where the fourth regions 2200B, 2300B, and 2400B overlap each other, and the second vias 2121 and 2122 may be formed inside the area where the fourth regions 2200B, 2300B, and 2400B overlap each other.

In one embodiment, vias 2111 and 2112 are connected to pads that electrically connect to circuitry on an active surface of first semiconductor chip 2100, but vias 2121 and 2122 are connected to dummy pads that connect to vias 2221 and 2222 respectively, but do not electrically connect to circuitry on an active surface of first semiconductor chip 2100. As such, the paths for providing VDD_{—}1^{st} to first semiconductor chip 2100 and for providing VDD_{—}2^{nd} to second semiconductor chips 2200 to 2400 are separate, electrically isolated paths.

In FIG. 3A, the second semiconductor chips 2200 through 2400 receive the second internal power voltage VDD_{—}2nd through the same path, but the present invention is not limited thereto. In other words, other vias (not shown) may be disposed in the second region 2100B and the fourth regions 2200B, 2300B, and 2400B, and some of the second semiconductor chips may include dummy pads. As such, the second semiconductor chips 2200 through 2400 may be designed to receive the second internal power voltage VDD_{—}2nd through different paths, i.e., through the other vias.

In FIG. 3A, active regions (regions where a circuit is disposed) of the memory controller 1000 or the memory chips 2100 through 2400 are disposed on an upper surface of a corresponding chip, for example, a surface disposed opposite to the substrate 2500. However, locations of the active regions are not limited thereto, and for example, the active regions may be disposed on bottom surface of the memory controller 1000 or each of the semiconductor chips 2100 through 2400, for example, a surface facing the substrate 2500. In such a case, the memory controller 1000 may directly receive an external signal without using a via. Also, in this case, the semiconductor chip 2100 may directly receive a signal through the substrate 2500 without using a via, and the signal may be provided to the semiconductor chips 2200 through 2400 through a via formed on the semiconductor chip 2100. For example, the semiconductor chip 2100 may transmit a signal to the semiconductor chip 2200 disposed on the semiconductor chip 2100, through a via formed inside the semiconductor chip 2100, and any one of the semiconductor chips 2200 through 2400, for example, the semiconductor chip 2300, may transmit a signal to the semiconductor chip 2400 disposed on the semiconductor chip 2300 through a via formed inside the semiconductor chip 2300. Accordingly, structures of the vias disposed in the memory controller 1000 or the semiconductor chips 2100 through 2400 may be partially changed based on location of an active surface of a semiconductor chip. FIG. 3A also shows pads disposed to electrically connect to the semiconductor chips 2100 through 2400, but another conductive unit, for example, a flip chip conductive unit such as a conductive bump, may be used instead of the pad.

FIG. 3B shows the memory controller 1000 electrically connected to the memory device 2000 through wires, according to another embodiment. As shown in FIG. 3B, the memory controller 1000 is connected to a circuit pattern of the substrate 2500 through at least one wire. A part of the at least one wire is electrically connected to a port formed on the external surface of the memory card 100, and another part of the at least one wire is electrically connected to the memory device 2000 through the substrate 2500. For example, as shown in FIG. 3B, the memory controller 1000 receives the power voltage VDD from outside the memory card 100 through a wire, and generates the first internal power voltage VDD_{—}1st and the second internal power voltage VDD_{—}2nd by using the received power voltage VDD. The generated first internal power voltage VDD_{—}1st and the second internal power voltage VDD_{—}2nd are connected to the substrate 2500 through different wires. The first internal power voltage VDD_{—}1st and the second internal power voltage VDD_{—}2nd are electrically connected respectively to the first vias 2111 and 2112, and the second vias 2121 and 2122 of the first semiconductor chip 2100 through the circuit pattern on the substrate 2500. As described above, the first internal power voltage VDD_{—}1st and the second internal power voltage VDD_{—}2nd transmitted to the memory device 2000 may be provided to the semiconductor chips 2100 through 2400 in the same or similar manner as described with respect to FIG. 3A.

FIG. 3C shows an example of providing the ground voltage VSS from outside the memory card 100 to the memory device 2000, according to one embodiment. According to FIG. 3C, i.e., the cross-sectional view taken along the line B-B′ of the memory card 100 of FIG. 2, a port of the memory card 100 may receive the ground voltage VSS. As shown in FIG. 3C, the ground voltage VSS may be provided to the memory device 2000 in the same or similar manner as described with respect to FIGS. 3A and 3B. For example, the memory controller 1000 may include a plurality of vias 1024, 1025, and 1026, and the via 1024 may be electrically connected to a port that receives the ground voltage VSS from outside the memory card 100. In one embodiment, the memory controller 1000 generates the first and second internal ground voltages VSS_{—}1st and VSS_{—}2nd by using the ground voltage VSS, and the generated first and second internal ground voltages VSS_{—}1st and VSS_{—}2nd are transmitted to the circuit pattern of the substrate 2500 respectively through the vias 1025 and 1026. The first internal ground voltage VSS_{—}1st is connected to first vias 2113 and 2114 of the first semiconductor chip 2100, and the second internal ground voltage VSS_{—}2nd is connected to second vias 2123 and 2124 of the first semiconductor chip 2100. In FIG. 3C, the memory controller 1000 receives the ground voltage VSS through the vias 1024, 1025, and 1026, and provides the first and second internal ground voltages VSS_{—}1st and VSS_{—}2nd to the memory device 2000, but the memory controller 1000 and the substrate 2500 may be connected to each other by using the at least one wire as shown in FIG. 3B, instead of using the vias 1024, 1025, and 1026. Similar to FIG. 3A described above, vias 2223 and 2224, 2333 and 2324, and 2423 and 2424 may provide VSS_{—}2^{nd} to respective second semiconductor chips 2200 through 2400.

In FIGS. 3D and 3E, the size (e.g., width or area) of the first semiconductor chip 2100 and the sizes of the second semiconductor chips 2200 through 2400 included in the memory device 2000, as well as their alignments, are different from the embodiments shown in FIGS. 3A and 3B. For convenience of description, only the memory device 2000 is illustrated in FIGS. 3D and 3E.

As shown in FIGS. 3D and 3E, the physical size (e.g., area layout dimensions) of the first semiconductor chip 2100 may be larger than the sizes of the second semiconductor chips 2200 through 2400, if the physical size of the second region 2100B of the first semiconductor chip 2100 is larger than the physical sizes of the fourth regions 2200B, 2300B, and 2400B of the second semiconductor chips 2200 through 2400, while the size of the first region 2100A of the first semiconductor chip 2100 is identical to the sizes of the third regions 2200A, 2300A, and 2400A of the second semiconductor chips 2200 through 2400. One or more memory cell arrays may be disposed in the first region 2100A of the first semiconductor chip 2100 and the third regions 2200A, 2300A, and 2400A of the second semiconductor chips 2200 through 2400. In one embodiment, the memory cells in a each region 2100A-2400A may also have the same storage capacity as each other, such that each can store the same amount of data. The configuration shown in FIGS. 3A-3E may be used for other semiconductor chips other than memory. For example, although not illustrated in FIG. 3D, a logic array may be disposed instead of the memory cell array, in the first region 2100A and the third regions 2200A, 2300A, and 2400A.

While stacking the second semiconductor chips 2200 through 2400 on the first semiconductor chip 2100 in FIG. 3D, the center of the fourth regions 2200B, 2300B, and 2400B are aligned with the center of the second region 2100B. In one embodiment, edges of the third regions 2200A, 2300A, and 2400A do not align with edges of the first region 2100A. In this case, the first vias 2111 and 2112 may be disposed proximate the edge of the second region 2100B, and the second vias 2121 and 2122 may be disposed toward the center of the second region 2100B, between the first vias 2111 and 2112.

FIG. 3E shows a different embodiment. While stacking the second semiconductor chips 2200 through 2400 on the first semiconductor chip 2100 in FIG. 3E, first edges of the second semiconductor chips 2200 through 2400 may be aligned to a first edge of the first semiconductor chip 2100, but second edges of the semiconductor chips 2200 through 2400 do not align with a second edge of the first semiconductor chip 2100. Also, when the size of the first region 2100A of the first semiconductor chip 2100 is identical to the sizes of the third regions 2200A, 2300A, and 2400A of the second semiconductor chips 2200 through 2400, first edges of the fourth regions 2200B, 2300B, and 2400B are aligned to a first edge of the second region 2100B, but second edges of fourth regions 2200B, 2300B, and 2400B do not align with a second edge of the second region 2100B. In this case, the second vias 2121 and 2122 may be disposed in an area adjacent to a first edge of the second region 2100B aligned with first edges of the fourth regions 2200B, 2300B, and 2400B, and within an area of overlapping fourth regions 2200B-2400B, and the first vias 2111 and 2112 may be disposed in an area adjacent to a second edge of the second region 2100B opposite the first edge of the second region 2100B, but outside the area of the fourth regions 2200B-2400B.

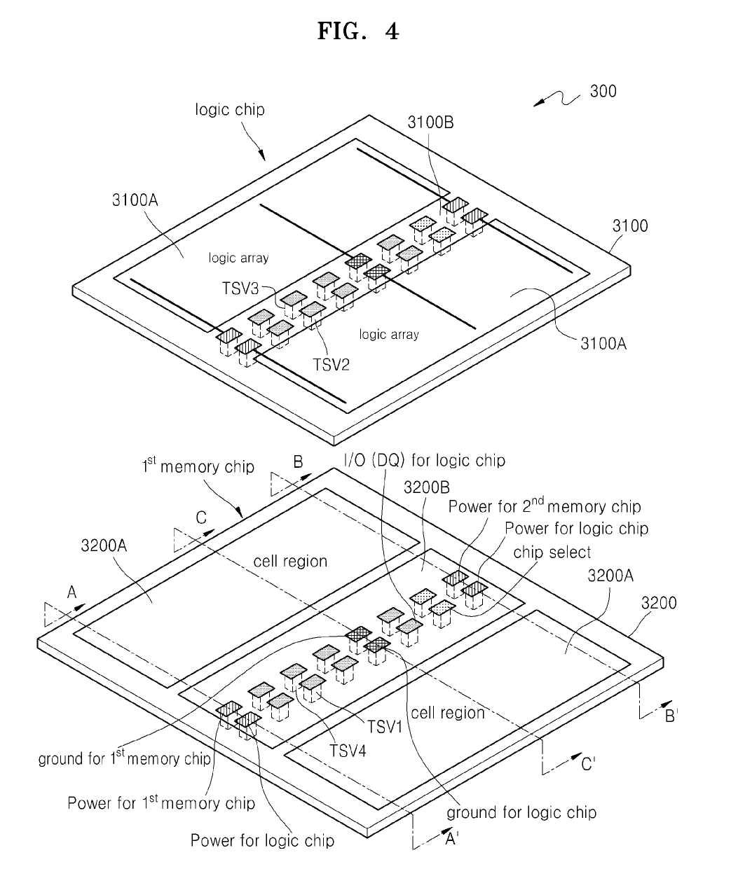

FIG. 4 is an exemplary diagram of a memory card 300 according to another embodiment.

As shown in FIG. 4, the memory card 300 may include a first memory chip 3200 disposed in a lower portion of the memory card 300, and a logic chip 3100 disposed in an upper portion of the memory card 300 and operating similarly to the memory controller 1000 in FIG. 1, wherein the first memory chip 3200 and the logic chip 3100 form a stacked structure. The logic chip 3100 may be smaller than the first memory chip 3200 in size, and thus the logic chip 3100 may be stacked on an upper part (e.g., a top surface) of the first memory chip 3200. Only one memory chip, namely, the first memory chip 3200, is illustrated in FIG. 4 for convenience of description. However, the disclosed embodiments are not limited thereto, and a plurality of memory chips may be included in the memory card 300. One or more memory chips from among the plurality of memory chips may operate as a master chip, and the remaining memory chips may operate as a slave chip. In the embodiment of FIG. 4, it is assumed that the first memory chip 3200 is a master chip. Also, in FIG. 4, the logic chip 3100 is stacked on the upper part of the first memory chip 3200, but alternatively, the first memory chip 3200 may be stacked on an upper part of the logic chip 3100. In addition, one or more other memory chips may be positioned between the first memory chip 3200 and the logic chip 3100.

The first memory chip 3200 includes a first region 3200A where at least a first memory cell array is disposed, and a second region 3200B where a plurality of pads and vias are disposed. In one embodiment, the first region 3200A may include two portions, as shown in FIG. 4, and the second region 3200B may be positioned between the two portions of the first region. The logic chip 3100 includes a third region 3100A where a logic array is disposed, and a fourth region 3100B where a plurality of pads and vias are disposed. The third region 3100A may include two portions, as shown in FIG. 4, and the fourth region 3100B may be positioned between the two portions of the third region. In one embodiment, when the logic chip 3100 is stacked on the upper part of the first memory chip 3200 (or on the upper part of another memory chip stacked on the first memory chip 3200), the vias formed in the second region 3200B are electrically connected to ports of the memory card 300 through a circuit pattern of a substrate (not shown), and the vias formed in the fourth region 3100B are electrically connected to pads in the second region 3200B that connect to the vias formed in the second region.

External signals received from an external host (not shown) are provided to the logic chip 3100. That is, in one embodiment, certain vias in the first memory chip 3200 and any other memory chips stacked on the first memory chip 3200 electrically connect to vias in the first logic chip 3100 to provide external signals to the first logic chip 3100 (e.g., dummy pads may be used on the first memory chip 3200 and other memory chips, similarly to those described above). The logic chip 3100 receives the external signals from the external host, and generates internal signals by using the external signals. The internal signals generated in the logic chip 3100 are provided to the first memory chip 3200 and optionally to other memory chips stacked on the first memory chip 3200 through vias and pads on the memory chips, and the signals may be provided to circuitry on one or more of the memory chips through the vias.

The external signals are provided into the logic chip 3100 through the via formed in the second region 3200B and the via formed in the fourth region 3100B. For example, the second region 3200B includes a first via TSV1 that is electrically connected to the external host. Also, the fourth region 3100B includes a second via TSV2 that is aligned with the first via TSV1 to be electrically connected to the first via TSV1. The external signals are first provided to the logic chip 3100 through the first via TSV1 and the second via TSV2. The logic chip 3100 generates the internal signals by processing the external signals.

The internal signals are provided to the first memory chip 3200. When a plurality of memory chips are included in the memory card 300, the internal signals may be provided to any selected memory chip, or commonly provided to at least two memory chips. The fourth region 3100B includes a third via TSV3 that provides the internal signals to the first memory chip 3200. The first memory chip 3200 receives the internal signals through the third via TSV3. If another memory chip (not shown) is disposed below the first memory chip 3200, the second region 3200B of the first memory chip 3200 may include a fourth via TSV4 that is aligned with the third via TSV3 to be electrically connected to the third via TSV3, so as to transmit the internal signals received through the third via TSV3 to the other memory chip.

In the memory card 300 of FIG. 4, a path for providing the external signal to the logic chip 3100 and a path for providing the internal signal from the logic chip 3100 to the first memory chip 3200 may be independently formed, for example, using different stacks of vias. In the case where a plurality of memory chips are included, some of the internal signals are commonly provided to at least two memory chips, and the rest of the internal signals may be commonly provided to other memory chips, or may be independently provided to each memory chip, or signals may be provided to the memory chips according to some combination of the two configurations (e.g., in a stack of 6 memory chips, a first stack of vias may commonly provide the internal signal to three of the chips, a second stack of vias may commonly provide the internal signal to two of the remaining chips, and a third stack of vias may individually provide the internal signal to the last remaining chip, though other combinations are possible). By using such characteristics, the internal signals that may remarkably deteriorate a memory operation when there is noise may be provided to different sets of memory chips through different paths. For example, a path of an internal power voltage provided to one memory chip and a path of an internal power voltage provided to another memory chip are independent from each other.

Referring to FIG. 4, paths for providing the power voltage VDD, the ground voltage VSS, and a data signal DQ to the logic chip 3100 and the first memory chip 3200 are illustrated. In addition, various signals may be transmitted to the memory card 300 by using the same or similar manner as described with respect to FIG. 4. For example, when a plurality of memory chips are included in the memory card 300, a chip select signal CHIP SELECT for selecting one or more memory chips from among the plurality of memory chips may be provided to the memory card 300. The chip select signal CHIP SELECT is first provided to circuitry in the logic chip 3100, and the logic chip 3100 may generate an internal chip select signal (not shown) by using the chip select signal CHIP SELECT. If a memory operation of the memory card 300 operates based on a unit of banks or ranks, the internal chip select signal may be provided only to a master chip from among the plurality of memory chips. Alternatively, when the memory operation of the memory card 300 operates based on chip units, the internal chip select signal for controlling a memory chip selection may be provided to each of the plurality of memory chips. A selection operation of the memory chips may be directly controlled by the external host, and here, the chip select signal CHIP SELECT from the external host may be directly provided to each memory chip through the corresponding via and pad.

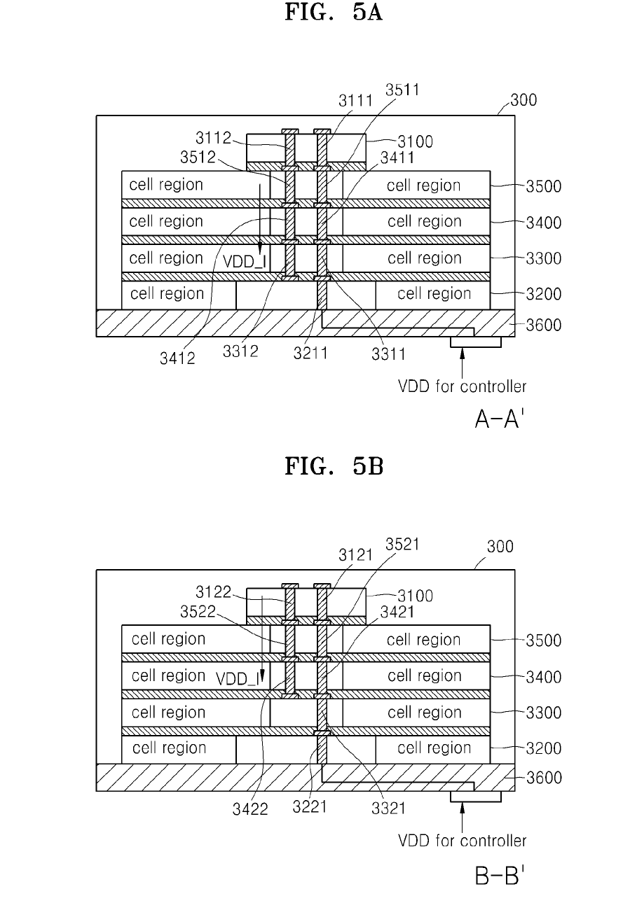

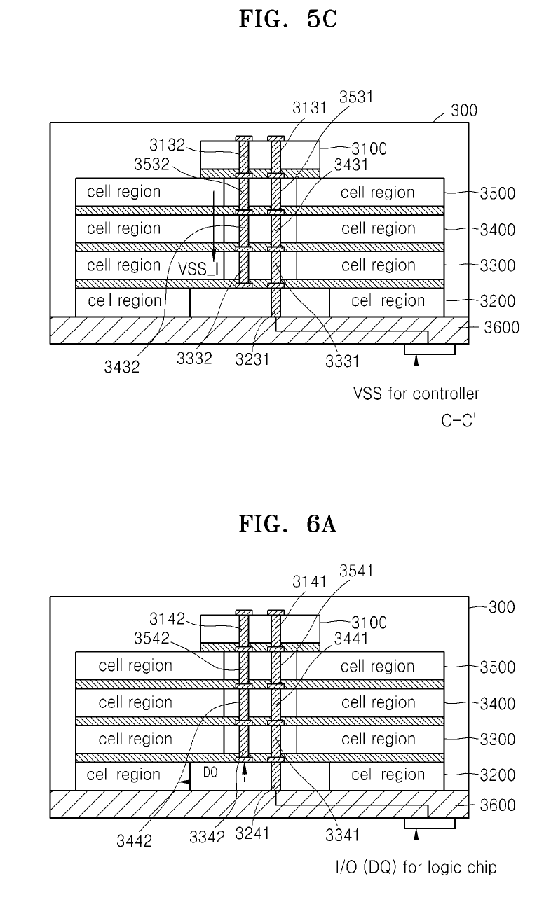

FIGS. 5A through 5C are exemplary diagrams for describing signal transmitting paths in the memory card 300 of FIG. 4, according to certain embodiments. FIG. 5A is a cross-sectional view taken along a line A-A′ of the memory card 300 of FIG. 4, FIG. 5B is a cross-sectional view taken along a line B-B′ of the memory card 300 of FIG. 4, and FIG. 5C is a cross-sectional view taken along a line C-C′ of the memory card 300 of FIG. 4.

As shown in FIG. 5A, the memory card 300 includes the logic chip 3100 and a plurality of first through fourth memory chips 3200, 3300, 3400, and 3500. The logic chip 3100 and the first through fourth memory chips 3200 through 3500 may be stacked in a single stack on one surface of a substrate 3600. In FIG. 4, only the first memory chip 3200 is illustrated for convenience of description; however the disclosed embodiments are not limited thereto, and the plurality of first through fourth memory chips 3200 through 3500 may be included as shown in FIG. 5A. It is assumed that the first memory chip 3200 is a master chip and the second through fourth memory chips 3300 through 3500 are slave chips. The second through fourth memory chips 3300 through 3500 may be stacked on an upper part (e.g., top surface) of the first memory chip 3200, and the logic chip 3100 may be stacked on an upper portion of the fourth memory chip 3500.

As shown in FIG. 5A, first vias 3211, 3311, 3411, and 3511 respectively formed in the first through fourth memory chips 3200 through 3500, and a second via 3111 formed in the logic chip 3100 are vertically aligned with each other to form a first stack of vias. The first via 3211 of the first memory chip 3200 is electrically connected to a port of the memory card 300, and for example, the port illustrated in FIG. 5A is a port for receiving the power voltage VDD from outside the memory card 300. The power voltage VDD is provided to the logic chip 3100 through the first stack of vias 3111, 3211, 3311, 3411, and 3511. The logic chip 3100 generates an internal power voltage VDD_I that is provided to the first through fourth memory chips 3200 through 3500, by using the power voltage VDD.

The internal power voltage VDD_I is provided to the first through fourth memory chips 3200 through 3500 through a third via 3112 formed in the logic chip 3100, and fourth vias 3312, 3412, and 3512 respectively formed in the second through fourth memory chips 3200 through 3500. Collectively, third via 3112 and fourth vias 3312, 3412, and 3512 form a second stack of vias. In FIG. 5A, the internal power voltage VDD_I is provided to the first memory chip 3200. As shown in FIG. 5A, the internal power voltage VDD_I provided through the second stack of vias to a pad of the first memory chip. The internal power voltage VDD_I provided to the pad of the first memory chip 3200 is transmitted to the first memory chip 3200 through a circuit pattern (not shown) formed in the first memory chip 3200.

FIG. 5B shows the internal power voltage VDD_I transmitted to the second memory chip 3300, according to one embodiment. As shown in FIG. 5B, first vias 3221, 3321, 3421, and 3521 respectively formed in the first through fourth memory chips 3200 through 3500, and a second via 3121 formed in the logic chip 3100 are vertically aligned with each other to form a third stack of vias. As shown in FIG. 5B, a first via 3221 of the first memory chip 3200 is electrically connected to a port of the memory card 300 for receiving the power voltage VDD from outside the memory card 300. The received power voltage VDD is transmitted to the logic chip 3100 through the third stack of vias. The logic chip 3100 generates the internal power voltage VDD_I by using the power voltage VDD, and transmits the internal power voltage VDD_I to the second memory chip 3300. The internal power voltage VDD_I is transmitted to a pad of the second memory chip 3300 through a third via 3122 of the logic chip 3100 and fourth vias 3422 and 3522 respectively of the third and fourth memory chips 3400 and 3500. Collectively, third via 3122 and fourth vias 3422, and 3522 form a fourth stack of vias.

Although the first stack of vias and third stack of vias in respective FIGS. 5A and 5B are described separately above and may comprise different stacks of vias connected to different ports on a memory card, a single stack of vias may be used to transmit an external voltage from a single port on the memory card to the logic chip 3100.

FIG. 5C illustrates an internal ground voltage VSS_I transmitted to the first memory chip 3200, according to one embodiment. As shown in FIG. 5C, another first via 3231 of the first memory chip 3200 is electrically connected to a port of the memory card 300 for receiving the ground voltage VSS from outside the memory card 300. The ground voltage VSS is transmitted to the logic chip 3100 through first vias 3331, 3431, and 3531 respectively of the second through fourth memory chips 3300, 3400, and 3500, and a second via 3131 of the logic chip 3100. Vias 3231, 3331, 3431, 3531, and 3131 together form a fifth stack of vias. The internal ground voltage VSS_I generated in the logic chip 3100 is transmitted to the pad of the first memory chip 3200 through a third via 3132 of the logic chip 3100, and fourth vias 3332, 3432, and 3532 of the second through fourth memory chips 3330, 3400, and 3500, which collectively form a sixth stack of vias. In one embodiment, each of fourth vias 3332, 3432, 3532, and 3132 connect to pads on respective chips 3200, 3200, 3400, and 3500. Each of the pads may be electrically connected to circuitry in a respective chip, in which case the pad transmits VSS_I to the chip circuitry, or may not electrically connect to any circuitry in a respective chip (e.g., may connect to a dummy pad), in which case the pad does not transmit VSS_I to chip circuitry. As such, certain chips may share paths with other chips for receiving VSS_I, and certain chips may receive VSS_I individually and separately from other chips.

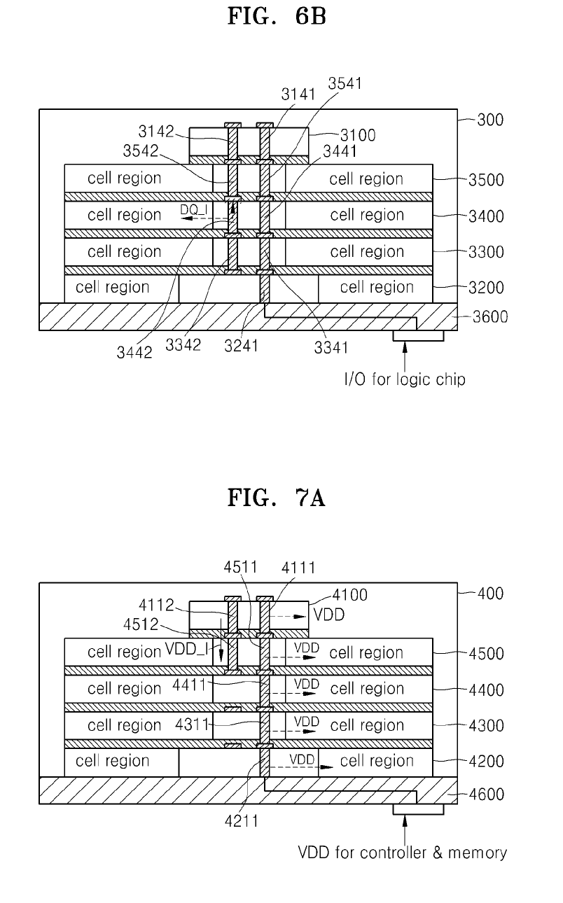

FIGS. 6A and 6B are exemplary diagrams for describing signal transmitting paths of external data and internal data signals, according to certain embodiments. As shown in FIGS. 6A and 6B, the memory card 300 includes the logic chip 3100 and the first through fourth memory chips 3200 through 3500, wherein the logic chip 3100 and the first through fourth memory chips 3200 through 3500 include vias for transmitting the data signal DQ and an internal data signal DQ_I. In FIGS. 6A and 6B, the internal data signal DQ_I provided to the first through fourth memory chips 3200 through 3500 through a common path. However, the present invention is not limited thereto, and the internal data signal DQ_I may be transmitted to the first through fourth memory chips 3200 through 3500 through different paths as described above.

FIG. 6A shows the internal data signal DQ_I provided to the first memory chip 3200. As shown in FIG. 6A, the data signal DQ is provided to the logic chip 3100 through a stack of vias including first vias 3241, 3341, 3441, and 3541 respectively formed in the first through fourth memory chips 3200 through 3500, and a second via 3141 formed in the logic chip 3100. The logic chip 3100 generates the internal data signal DQ_I by processing the data signal DQ. When a memory operation is performed on the first memory chip 3200, the internal data signal DQ_I is provided to the first memory chip 3200. Here, the internal data signal DQ_I is provided to the pad of the first memory chip 3200 through a stack of vias including a third via 3142 of the logic chip 3100 and fourth vias 3342, 3442, and 3542 respectively of the second through fourth memory chips 3300 through 3500. The pad to which the internal data signal DQ_I is transmitted may be connected to a circuit pattern (not shown) formed in the first memory chip 3200, according to a predetermined control operation (e.g., chip select, read, write, etc.). However, other pads to which the internal data signal DQ_I is transmitted may be disconnected from a circuit pattern of a corresponding memory chip, according to a predetermined control operation. As such, circuit patterns of different chips may be selectively electrically connected to or disconnected from a pad that receives data signal DQ_I, according to operations to be performed on the chips. In other words, all of vias 3142, 3542, 3442, and 3342 may connect to pads in respective chips 3500, 3400, 3300, and 3200 that are connected to switches or logic circuitry in those chips, but based on control operations, the switches or logic circuitry may selectively electrically connect or disconnect the pads to a memory cell array in the memory. The data transmission operation described above relates to a data recording/writing operation, but a data reading operation may also be performed in a similar manner. For example, when data is read from the first memory chip 3200, the data may be provided to the outside of the memory card 300 in a reverse direction of the signal path described above.

FIG. 6B shows the internal data signal DQ_I provided to the third memory chip 3400. In FIG. 6B, the internal data signal DQ_I generated in the logic chip 3100 is transmitted to the third memory chip 3400. Here, a pad disposed in the third memory chip 3400 is connected to a circuit pattern (not shown) in the third memory chip 3400 according to a predetermined control operation, and the internal data signal DQ_I is transmitted to a memory cell of the third memory chip 3400 through the circuit pattern. As described above, during a data reading operation, data to be read may be transmitted in a reverse direction of a path of data to be recorded. FIGS. 6A and 6B show two individual stacks of vias for transmitting each of the data signal DQ and the internal data signal DQ_I. However, for each signal, multiple stacks of vias providing isolated, independent paths may be used, in a manner similar to that described in the embodiments discussed above.

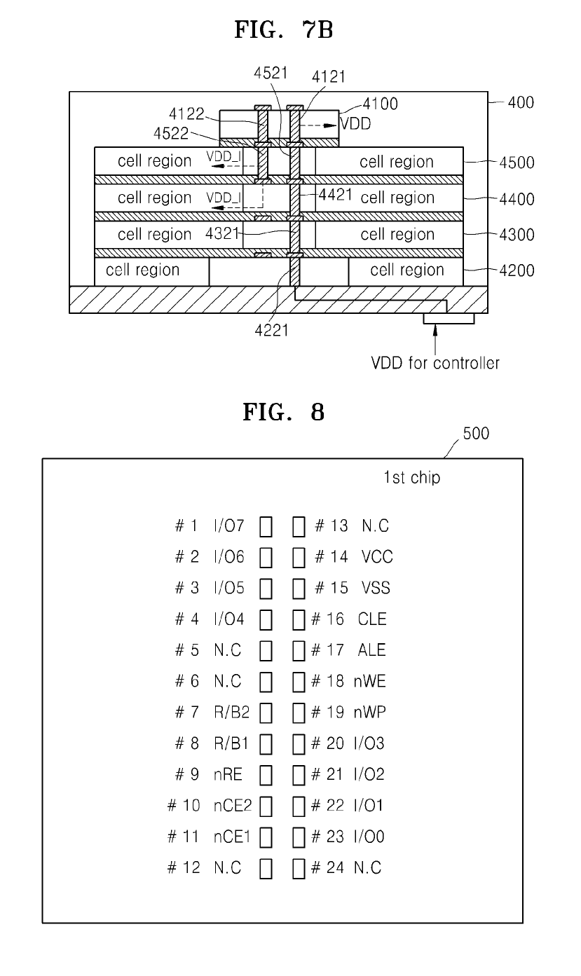

FIGS. 7A and 7B are exemplary diagrams of memory cards 400 according to other embodiments, wherein the power voltage VDD is transmitted into the memory card 400 by using various methods. In addition, although power voltage VDD is described below, the embodiments of FIGS. 7A and 7B are also applicable to a ground voltage VSS.

As shown in FIG. 7A, the memory card 400 includes a logic chip 4100 and a plurality of first through fourth memory chips 4200, 4300, 4400, and 4500. The first through fourth memory chips 4200 through 4500 respectively include first vias 4211, 4311, 4411, and 4511 for receiving the power voltage VDD from outside the memory card 400, and the logic chip 4100 may include a second via 4111 for receiving the power voltage VDD. The first via 4211 of the first memory chip 4200 is electrically connected to a port of the memory card 400 to receive the power voltage VDD, and the power voltage VDD transmitted to the first via 4211 may be provided to the first through fourth memory chips 4300 through 4500 and the logic chip 4100 through a common path.

During a memory operation, the internal power voltage VDD_I may be generated by receiving the power voltage VDD from outside the memory card 400. The logic chip 4100 generates the internal power voltage VDD_I by using the power voltage VDD, and provides the internal power voltage VDD_I to the first through fourth memory chips 4200 through 4500. The logic chip 4100 may further include a third via 4112 to transmit the internal power voltage VDD_I. In FIG. 7A, the internal power voltage VDD_I is transmitted to the third memory chip 4400. The internal power voltage VDD_I is transmitted to a pad of the third memory chip 4400 through the third via 4112 and a fourth via 4512 of the fourth memory chip 4500. Although not illustrated in FIG. 7A, the internal power voltage VDD_I may be transmitted to the first, second, and fourth memory chips 4200, 4300, and 4500 through a common path, or through different paths (vias).

FIG. 7B shows signal paths of the power voltage VDD and the internal power voltage VDD_I, according to another embodiment. As shown in FIG. 7B, the first through fourth memory chips 4200 through 4500 respectively include first vias 4221, 4321, 4421, and 4521 to receive the power voltage VDD from outside the memory card 400, and the logic chip 4100 includes a second via 4121 for receiving the power voltage VDD. The power voltage VDD is transmitted to the logic chip 4100 through the first vias 4221, 4321, 4421, and 4521, and the second via 4121. The logic chip 4100 generates the internal power voltage VDD_I by using the power voltage VDD.

When the memory card 400 includes the plurality of first through fourth memory chips 4200 through 4500, the internal power voltage VDD_I may be provided to the first through fourth memory chips 4200 through 4500 through a common path or different paths (e.g., through a single stack of vias or through multiple stacks of vias). When the first through fourth memory chips 4200 through 4500 receive the internal power voltage VDD_I through the common path, the first through fourth memory chips 4200 through 4500 may be vulnerable to noise. On the other hand, when each of the first through fourth memory chips 4200 through 4500 receives the internal power voltage VDD_I through a different path, a plurality of vias are formed in the logic chip 4100 and the first through fourth memory chips 4200 through 4500, and thus it may be difficult to integrate the memory card 400. Accordingly, the first through fourth memory chips 4200 through 4500 may be grouped, and the internal power voltage VDD_I (or the internal ground voltage VSS_I) may be transmitted through different paths according to groups.

In FIG. 7B, two memory chips are grouped, and thus two memory chips in the same group receive the internal power voltage VDD_I through a common path. The logic chip 4100 transmits the internal power voltage VDD_I through a third via 4122, and the fourth chip 4500 includes a fourth via 4522 aligned with the third via 4122. The internal power voltage VDD_I is transmitted to the third and fourth memory chips 4400 and 4500 through the third via 4122 and the fourth via 4522, through a corresponding pad formed on each of the third and fourth memory chips 4400 and 4500 and connected to circuitry on those chips.

Although not illustrated in FIG. 7B, when the internal power voltage VDD_I is provided to the first and second memory chips 4200 and 4300, the internal power voltage VDD_I may be transmitted through another third via (not shown) formed in the logic chip 4100, and other fourth vias (not shown) formed in the second through fourth memory chips 4300 through 4500. For example, the first memory chip 4200 may receive the internal power voltage VDD_I through another third via of the logic chip 4100 and another fourth vias of the second through fourth memory chips 4300 through 4500, and the second memory chip 4300 may receive the internal power voltage VDD_I through the other third via of the logic chip 4100 and the other fourth vias of the third and fourth memory chips 4400 and 4500.

FIG. 8 is an exemplary diagram of signals provided to a memory device included in a memory card 500, according to one embodiment. For convenience of description, a first semiconductor chip 1st chip including conductive units for receiving at least one signal from a memory controller (not shown) is shown as the memory device included in the memory card 500. The first semiconductor chip 1st chip may be a master chip included in the memory device, and may include a memory cell array, aside from a pad and vias, or a logic array instead of the memory cell array.

As shown in FIG. 8, the first semiconductor chip 1st chip includes a plurality of conductive units for communicating various signals with the memory controller. If a substrate (not shown) including a circuit pattern is attached to a first surface of the first semiconductor chip 1st chip, and pads are included on a second surface, i.e., a surface opposite of the first surface, the conductive units in FIG. 8 may be through substrate vias. Labels NC, I/O, R/B, CE, VDD, VSS, and WP in FIG. 8 denote functions of vias communicating with the memory controller.

For example, a via indicated by I/O 0 may communicate a signal indicating a program/erase state, and transmit information about whether the program/erase operation is normal state or not. Also, a via indicated by I/O 7 may communicate a signal indicating a recording prohibition/possible state, and a via indicated by R/B may communicate a signal indicating a ready or busy state. Also, a via indicated by CE may communicate a signal for selecting a semiconductor chip included in the memory device (e.g., chip enable), and vias indicated by Vdd and Vss may respectively communicate a power voltage and a ground voltage for operating the memory device. Also, a via indicated by NC is an extra via that is not electrically connected to the semiconductor chip (e.g., it may be connected to a dummy pad and used to pass signals through to another chip stacked on the semiconductor chip). However, the structure shown in FIG. 8 is only one exemplary embodiment, and the conductive units of the memory device for communicating with the memory controller may be realized in any structure for communicating various signals that is consistent with the embodiments disclosed herein.

The vias illustrated in FIG. 8 may receive various internal signals from the memory controller, and some of the internal signals may be commonly provided to at least two memory chips of the memory device while the rest of the internal signals may be independently provided to each memory chip. For example, when an internal power voltage is independently provided to each memory chip, the memory controller may generate a plurality of internal power voltages, and the first semiconductor chip 1st chip may include a via to independently receive one of the internal power voltages. Alternatively, a chip select signal for selecting the semiconductor chips may be commonly provided to at least two memory chips, or may be independently provided to each memory chip. Noise may be generated while transmitting the internal signals, and internal signals to be commonly provided to the memory chips and internal signals to be independently provided to each memory chip may be classified considering deterioration characteristics of a memory operation due to the noise.

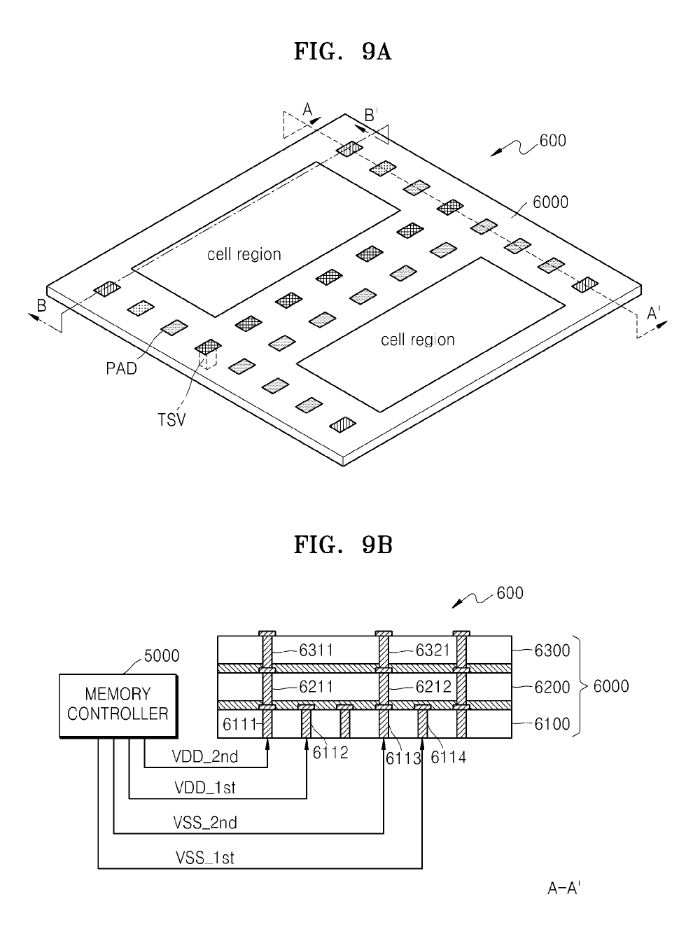

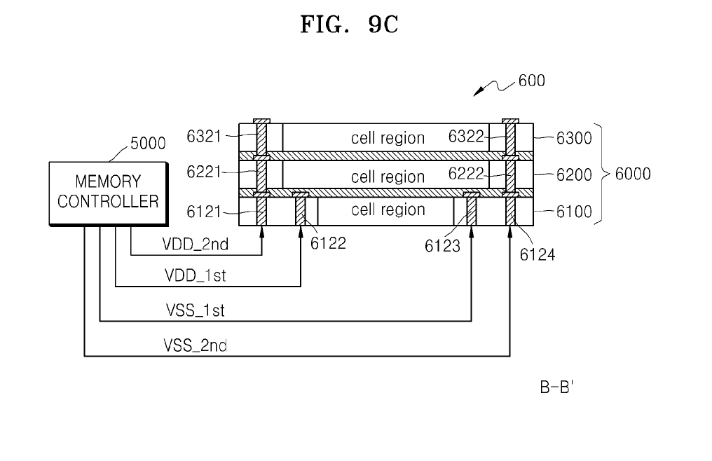

FIGS. 9A through 9C are exemplary diagrams of memory cards 600 according to other embodiments. Specifically, FIGS. 9A through 9C show a modified example in terms of locations of pads and vias of a semiconductor chip included in the memory card 600. FIG. 9A illustrates only a memory chip 6000 for convenience of description. The memory card 600 of FIG. 9A may also include a memory controller (not shown), and the memory controller may be disposed separately from the memory chip 6000 as described above, or stacked on the memory chip 6000.

As shown in FIG. 9A, the memory card 600 includes one memory chip, namely, the memory chip 6000. However, the disclosed embodiments are not limited thereto, and one or more memory chips may be included in the memory card 600. Like the memory chip 6000 of FIG. 9A, the plurality of memory chips may include pads and vias.

A plurality of pads PAD and vias TSV are formed on the memory chip 6000. In the previous embodiments described above, the pads PAD and vias TSV are disposed between portions of a cell region, but in another embodiment, the pads PAD and the vias TSV may be disposed in another region as well, such as an adjacent edge of the semiconductor chip 6000. Also, pads and vias may be disposed in a manner different from FIG. 9A.

FIG. 9B is an exemplary cross-sectional view taken along a line A-A′ of the memory card 600 of FIG. 9A. In FIG. 9B, the memory chip 6000 includes a plurality of first through third memory chips 6100 through 6300 that are vertically stacked on each other. As shown in FIG. 9B, each of the first through third memory chips 6100 through 6300 includes a plurality of pads and vias along the line A-A′. The vias included in the first memory chip 6100 may be electrically connected to a memory controller 5000. For example, vias 6111 and 6112 of the first memory chip 6100 respectively receive the second internal power voltage VDD_{—}2nd and the first internal power voltage VDD_{—}1st from the memory controller 5000. Also, vias 6113 and 6114 of the first memory chip 6100 respectively receive the second internal ground voltage VSS_{—}2nd and the first internal ground voltage VSS_{—}1st from the memory controller 5000.

The second and third memory chips 6200 and 6300 respectively include a plurality of vias 6211 and 6212, and 6311 and 6312, which are electrically connected to some of the vias 6111, 6112, 6113, and 6114 of the first memory chip 6100. The vias 6211, 6212, 6311, and 6312 of the second and third memory chips 6200 and 6300 are electrically connected to vias of the first memory chip 6100, which transmit a second internal signal. For example, the vias 6211 and 6212 of the second memory chip 6200 are respectively connected to the vias 6111 and 6113 of the first memory chip 6100, which respectively transmit the second internal power voltage VDD_{—}2nd and the second internal ground voltage VSS_{—}2nd. Also, the vias 6311 and 6312 of the third memory chip 6300 are respectively connected to the vias 6211 and 6212 of the second memory chip 6200.

FIG. 9C is an exemplary cross-sectional view taken along a line B-B′ of the memory card 600 of FIG. 9A. As shown in FIG. 9C, the first through third memory chips 6100 through 6300 may include a plurality of pads and vias proximate the edges thereof, and a plurality of pads and vias adjacent edges thereof. The first memory chip 6100 may include a plurality of vias 6121, 6122, 6123, and 6124 that are electrically connected to the memory controller 5000, and for example, may include the vias 6121 and 6122 that receive the first and second internal power voltages VDD_{—}2nd and VDD_{—}1st from the memory controller 5000, and the vias 6123 and 6124 that receive the first and second internal ground voltages VSS_{—}1st and VSS_{—}2nd from the memory controller 5000. Also, the second memory chip 6200 may include vias 6221 and 6222 for respectively receiving the second internal power voltage VDD_{—}2nd and the second internal ground voltage VSS_{—}2nd, and the third memory chip 6300 may include vias 6321 and 6322 for respectively receiving the second internal power voltage VDD_{—}2nd and the second internal ground voltage VSS_{—}2nd.

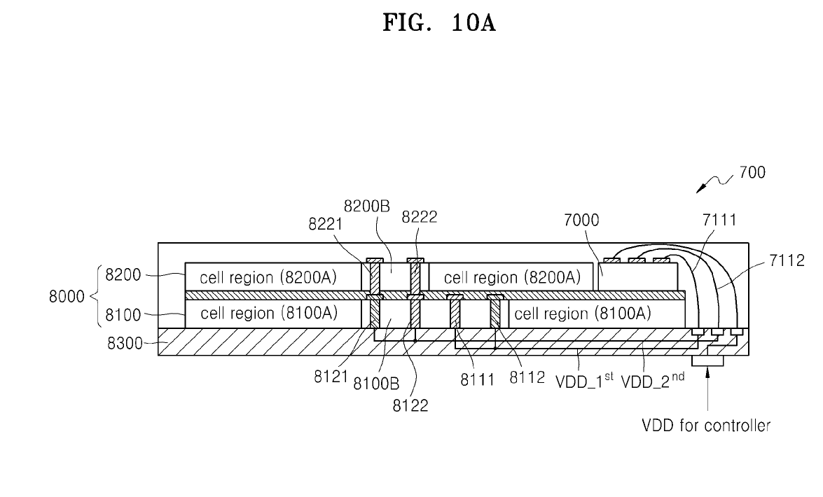

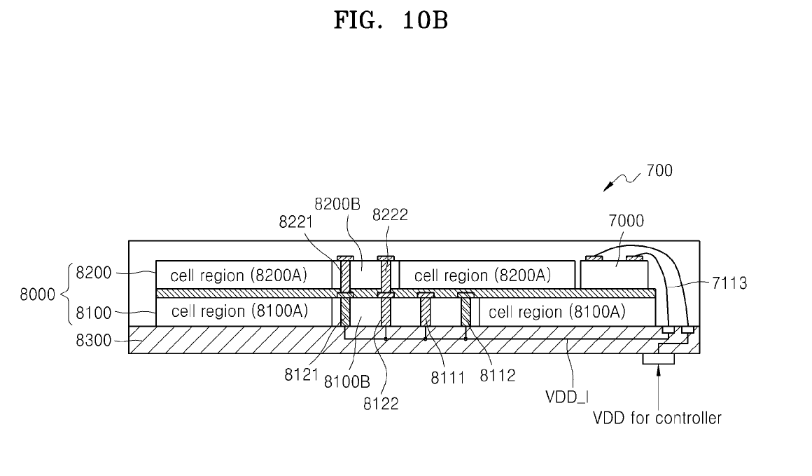

FIGS. 10A and 10B are exemplary diagrams of memory cards 700 according to other embodiments. As shown in FIGS. 10A and 10B, the memory cards 700 each include a memory controller 7000 and a memory device 8000, wherein the memory device 8000 may include a plurality of first and second memory chips 8100 and 8200. Specifically, the memory device 8000 includes the first and second memory chips 8100 and 8200 having different sizes, and for example, the first memory chip 8100 is larger than the second memory chip 8200. One first memory chip 8100 having a larger size than one second memory chip 8200 are illustrated in FIGS. 10A and 10B, but the present invention is not limited thereto and the first memory chip 8100 may include a plurality of chips that are collectively larger than second memory chip 8200, which also may include a plurality of chips.

While vertically stacking the first and second memory chips 8100 and 8200 of the memory device 800, the first memory chip 8100 having a larger size than the second memory chip 8200 is stacked on a substrate 8300, and the second memory chip 8200 having a smaller size than the first memory chip 8100 is stacked on an upper portion (e.g., on a top surface) of the first memory chip 8100. In FIGS. 10A and 10B, one edge of the second memory chip 8200 is aligned with an edge of the first memory chip 8100, but alternatively, a center of the second memory chip 8200 may be aligned with a center of the first memory chip 8100. The first memory chip 8100 includes a first region 8100A where a memory cell array is disposed, and a second region 8100B where pads and vias are disposed. The second memory chip 8200 includes a third region 8200A where a memory cell array is disposed, and a fourth region 8200B where a pad and vias are disposed. First vias 8111 and 8112 for transmitting internal signals into the first memory chip 8100, and second vias 8121 and 8122 for transmitting the internal signals to the second memory chip 8200 are disposed in the second region 8100B of the first memory chip 8100. Also, third vias 8221 and 8222 for receiving the internal signals are disposed in the fourth region 8200B of the second memory chip 8200.

While placing the memory controller 7000 in the memory card 700, the memory controller 7000 is stacked on the upper portion of the first memory chip 8100. In other words, since the second memory chip 8200 stacked on the upper portion of the first memory chip 8100 is smaller than the first memory chip 8100, when the second memory chip 8200 is stacked on the upper portion of the first memory chip 8100, a space is left in the upper portion. In order to reduce the size of the memory card 700, the memory controller 7000 is stacked on the space adjacent the second memory chip 8200 on the upper portion of the first memory chip 8100.

The memory controller 7000 is electrically connected to a port on an external surface of the memory card 700 through a circuit pattern formed on the substrate 8300. Accordingly, the memory card 700 further includes a conductive unit for connecting the memory controller 7000 and the port, and the conductive unit may be a wire. Also, the memory card 700 may also include another conductive unit for connecting the memory controller 7000 and the memory device 8000, and the other conductive unit may be a wire. In FIG. 10A, the memory controller 7000 receives the power voltage VDD from outside the memory card 700, and the first and second internal power voltages VDD_{—}1st and VDD_{—}2nd are provided to the memory device 8000 respectively through first and second wires 7111 and 7112. For example, the first internal power voltage VDD_{—}1st is provided to the first vias 8111 and 8112 of the first memory chip 8100 through the first wire 7111, and the second internal power voltage VDD_{—}2nd is provided to the second vias 8121 and 8122 of the first memory chip 8100 through the second wire 7112. Accordingly, the first and second internal power voltages VDD_{—}1st and VDD_{—}2nd are respectively provided from the memory controller 7000 to the first and second memory chips 8100 and 8200 through different, electrically isolated paths.

On the other hand, in FIG. 10B, the memory controller 7000 generates the internal power voltage VDD_I to be provided to the memory device 8000, by using the power voltage VDD received from outside the memory card 700, and the internal power voltage VDD_I is provided to the first and second memory chips 8100 and 8200 through an electrically connected path. The internal power voltage VDD_I generated in the memory controller 7000 is provided to the first and second vias 8111, 8112, 8121, and 8122 of the first memory chip 8100 through a wire 7113. The first vias 8111 and 8112 transmit the internal power voltage VDD_I into the first memory chip 8100, and the second vias 8121 and 8122 transmit the internal power voltage VDD_I into the second memory chip 8200. Alternatively, first vias 8111 and 8112 could be omitted, and internal power voltage VDD_I could be provided to first and second memory chips 8100 and 8200 through only the stack of vias including second vias 8121 and 8122. Although not illustrated in FIGS. 10A and 10B, other signals, such as a ground voltage, a command signal, and data signals, may be transmitted in the same manner as described with respect to FIGS. 10A and 10B. For example, an internal ground voltage (not shown) generated in the memory controller 7000 may be provided to the first and second memory chips 8100 and 8200 through a common path or different paths.

According to the above embodiments, generation of noise may be reduced by improving paths for transmitting various signals, which are realized in a memory card and a memory system, thereby improving operation characteristics of the memory card and the memory system.

While the above disclosure has been particularly shown and described with reference to exemplary embodiments thereof, it will be understood that various changes in form and details may be made therein without departing from the spirit and scope of the following claims.

What is claimed is:

1. A memory card comprising:
a plurality of ports formed on an external surface of the memory card;
a memory controller coupled to the plurality of ports and configured to communicate with an external host through the ports, and to generate a plurality of internal signals for controlling a memory operation based on signals received from the external host; and
a memory device coupled to the memory controller and comprising at least two semiconductor chips, which are vertically stacked on each other, wherein each semiconductor chip comprises a plurality of through substrate vias for receiving the plurality of internal signals from the memory controller,
wherein the memory controller generates first and second internal signals based on a first signal received through a first port, and the first and second internal signals are provided to the memory device respectively through first and second signal paths that are electrically isolated from each other.

2. The memory card of claim 1, wherein the first signal is a power voltage provided from the external host, and the first and second internal signals are respectively first and second internal power voltages generated by using the power voltage.

3. The memory card of claim 1, wherein the first signal is a command, address, or data signal provided from the external host, and the first and second internal signals are internal command or address, or internal data signals generated by using the first signal.

4. The memory card of claim 1, further comprising a package substrate, wherein the memory controller and the memory device are located on one surface of the package substrate and a circuit pattern for electrically connecting the memory controller and the at least two semiconductor chips is formed on the package substrate.

5. The memory card of claim 1, further comprising:
a first wire for electrically connecting the first port to the memory controller; and
second and third wires for respectively transmitting the first and second internal signals to the package substrate,
wherein at least a first of the at least two semiconductor chips of the memory device is electrically connected to the second wire to receive the first internal signal, and at least one additional chip of the at least two semiconductor chips is electrically connected to the third wire to receive the second internal signal.

6. The memory card of claim 1, wherein the memory device comprises:
a first semiconductor chip configured to receive the internal signals, and comprising a first through substrate via that is electrically connected to the memory controller to receive the first internal signal and a second through substrate via that is electrically connected to the memory controller to receive the second internal signal; and
at least one second semiconductor chip stacked on the first semiconductor chip to communicate with the first semiconductor chip and comprising a third through substrate via stacked on the second through substrate via and that is electrically connected to the second through substrate via.

7. The memory card of claim 6, wherein the first through substrate via forms the first signal path, and the second and third through substrate vias form the second signal path.

8. The memory card of claim 6, wherein the first semiconductor chip is a master chip comprising at least one of a logic circuit and a memory cell array, and the at least one second semiconductor chip is a slave chip comprising a NAND memory cell.

9. The memory card of claim 6, wherein the first through substrate via electrically connects to circuitry of the first semiconductor chip, and the second through substrate via does not electrically connect to circuitry of the first semiconductor chip.

10. A memory card comprising:
at least one first semiconductor chip comprising a first region where a memory cell array for storing data is disposed, and a second region where a first plurality of through substrate vias for transmitting signals are disposed; and
a second semiconductor chip comprising a third region where a logic array for controlling a memory operation is disposed, and a fourth region where a second plurality of through substrate vias for transmitting signals are disposed,
wherein at least one of the second through substrate vias is disposed to receive an external signal from outside the memory card.

11. The memory card of claim 10, wherein the second semiconductor chip is stacked on an upper part of the first semiconductor chip,
wherein the first semiconductor chip comprises at least one first through substrate via for transmitting the external signal to the second semiconductor chip, and
wherein the second semiconductor chip comprises a second through substrate via electrically connected to the first through substrate via to receive the external signal.

12. The memory card of claim 11, wherein the second semiconductor chip further comprises a third through substrate via that receives an internal signal generated by the second semiconductor chip based on the received external signal, and is configured to transmit the internal signal to the first semiconductor chip, and
the first semiconductor chip further comprises a fourth through substrate via electrically connected to the third through substrate via to receive the internal signal from the second semiconductor chip.

13. The memory card of claim 12, wherein an external data signal is provided to the first semiconductor chip through the first and second through substrate vias, and an internal data signal from the first semiconductor chip is transmitted to the second semiconductor chip through at least one of the third through substrate via and the fourth through substrate via.

14. The memory card of claim 12, wherein an external power voltage is provided to the first semiconductor chip through the first and second through substrate vias, and an internal power voltage from the first semiconductor chip is transmitted to the second semiconductor chip through at least one of the third through substrate via and the fourth through substrate via.

15. A memory card comprising:
a plurality of ports formed on an external surface of the memory card;
a memory controller for communicating to outside of the memory card through the plurality of ports, and configured to generate a plurality of internal signals for controlling a memory operation by using a signal received from outside the memory card; and
a memory device comprising first and second semiconductor chips that are vertically stacked on each other, each of the first and second semiconductor chips configured to receive the plurality of internal signals from the memory controller,
wherein the second semiconductor chip has a smaller area than the first semiconductor area, the second semiconductor chip is stacked on an upper portion of a part of the first semiconductor chip, and the memory controller is stacked on an upper portion of another part of the first semiconductor chip.

16. The memory card of claim 15, further comprising a package substrate, wherein the memory controller and the memory device are stacked on the package substrate and a circuit pattern for electrically connecting the memory controller and the memory device is formed on the package substrate, and
at least one of the first and second semiconductor chips comprises at least one through substrate via that is electrically connected to the circuit pattern to receive internal signals from the memory controller.

17. The memory card of claim 16, wherein the memory controller generates a first internal signal in response to a first signal received from outside the memory card, and provides the first internal signal to a first signal path of the circuit pattern, and
a through substrate via included in the first semiconductor chip and a through substrate via included in the second semiconductor chip are commonly connected to the first signal path.

18. The memory card of claim 16, wherein the first semiconductor chip comprises a first through substrate via for transmitting a signal to the first semiconductor chip and a second through substrate via for transmitting a signal to the second semiconductor chip,
the second semiconductor chip comprises a third through substrate via electrically connected to the second through substrate via to transmit a signal into the second semiconductor chip, and
the memory controller generates first and second internal signals in response to a first signal received from outside the memory card provides the first internal signal to the first semiconductor chip through the first through substrate via, and provides the second internal signal to the second semiconductor chip through the second and third through substrate vias.

19. The memory card of claim 15, wherein the first and second semiconductor chips are stacked on each other so that a first edge of the first semiconductor chip and a first edge of the second semiconductor chip are vertically aligned.

20. A memory system comprising:
a substrate;
a first semiconductor memory chip stacked on the substrate and comprising a first region where one or more memory cells for storing data are disposed, and a second region where at least a first through substrate via is formed;
a second semiconductor memory chip in a stack with the first semiconductor chip, and comprising a third region where one or more memory cells for storing data are disposed, and a fourth region where at least second and third through substrate vias are formed; and
a controller stacked on the substrate, the controller configured to transmit a signal through at least the third through substrate via to the first semiconductor memory chip.

21. The memory system of claim 20, wherein:
the first through substrate via and the third through substrate via comprise a first vertical stack of vias that are electrically connected, and the second through substrate via comprises a via not part of the vertical stack of vias.

22. The memory system of claim 21, wherein:
the controller is a logic chip in the stack with the first and second semiconductor chips;
the second semiconductor memory chip is positioned between the controller and the first semiconductor memory chip; and
the first semiconductor memory chip is configured to receive the signal from the controller through the second through substrate via.

23. The memory system of claim 22, wherein:
the memory system comprises a memory card; and
the controller is configured to receive a signal from outside the memory card through the first vertical stack of vias, to generate an internal signal based on the received signal, and to transmit the internal signal through the second through substrate via to the first semiconductor chip.

24. The memory system of claim 21, wherein:
the controller includes a fourth through substrate via electrically connected to the second through substrate via, and a fifth through substrate via electrically connected to the first and third through substrate vias.

25. The memory system of claim 24, wherein:
the fifth through substrate via is included in the first stack of through substrate vias; and
the fourth through substrate via is included in a second stack of vias including the fourth through substrate via and the second through substrate via.

26. The memory system of claim 21, wherein:
the second semiconductor memory chip is located between the first semiconductor memory chip and the substrate, and both the first semiconductor chip and the controller are located at a top surface of the second semiconductor memory chip.
